(19) United States
(12) Patent Application Publication
(10) Pub. No.: US 2007/0163678 A1
(43) Pub. Date: Jul. 19, 2007

(54) Gold or silver particles with paramagnetism, and composition containing thereof

(75) Inventor: Young-Nam Kim, Daejeon-city (KR)

Correspondence Address: THE WEBB LAW FIRM, P.C., 700 KOPPERS BUILDING, 436 SEVENTH AVENUE, PITTSBURGH, PA, 15219, US

(73) Assignee: Nano Plasma Center Co., Ltd., Yuseong-gu (KR)

(21) Appl. No.: 10/588,135

(22) PCT Filed: Apr. 1, 2005
(86) PCT No.: PCT/KR05/00964

§ 371 Date: Jul. 31, 2006

(30) Foreign Application Priority Data
Aug. 28, 2004 (KR) 10-2004-0068246
Dec. 9, 2004 (KR) 10-2004-0103324
Dec. 9, 2004 (KR) 10-2004-0103344
Dec. 11, 2004 (KR) 10-2004-0104660
Dec. 28, 2004 (KR) 10-2004-0114460

(51) Int. Cl. B22F 9/14; H01F 1/20

(52) U.S. Cl. 148/300; 252/62.51 R; 75/346; 75/348

(57) ABSTRACT

The present invention is related to gold or silver powder characterized by having paramagnetism. The gold or silver powder according to the present invention is a paramagnetic gold or silver powder having magnetism in the same direction as that of the external magnetic field in all temperature ranges. The paramagnetic gold or silver powder according to the present invention shows an extremely small coercive force, has no surface oxidation layers, is stable at a room temperature, has no cohesive property, and is highly dispersible.

### TECHNICAL FIELD

The present invention is related to gold or silver particles characterized by having paramagnetism, and to epilation agents, cosmetics, or toothpaste compositions containing the same.

### BACKGROUND ART

Studies on nano powder have been developed in Western Europe, U.S.A., Japan, etc. since they were begun in Russia in 1940s. Since the later part of 1980s, studies on nano powder have been conducted regularly in the fields of metals and ceramics. In the studies on nano powder, firstly, many processes of miniaturization of particles have been developed in order to utilize advantages of miniaturization of particle sizes such as purity, molding, mixing, fineness, etc., and it has been reported that nano-sized particles have shown many unusual properties.

The effects shown according to nano-sizing of particles include heat transmission according to the increase in specific surface area; absorption; adsorption; surface effects such as catalytic characteristics; single crystallization of polycrystals; appearance of new phase and lowering of melting point according to the change in the mode of bonding of crystals; absorbance and scattering effects of light, sound wave, electromagnetic wave, etc.; volumetric effects such as the change in electronic state of materials; electricity and heat transmission, fluidity; mixability; and interaction effects among particles such as compressibility, solid-phase reactivity, etc. Owing to such effects, particle characteristics are greatly different from those of the conventional μm-unit particles. It is, therefore, necessary to understand these characteristics and develop new application areas by putting them into practice.

The fields of application of nano particles vary according to whether nano particles are metals or ceramics. It has been published that nano powder has been applicable not only to highly functional and highly efficient materials designed in electronic, communication, and molecular units but also to drug transmission systems and selective new medicinal fields that have been proper for human bodies. In the bio-science field, it has been shown that it has been possible to develop synthetic skin in the hybrid system, analysis and manipulation of genes, and substitute materials for blood, and to make organs and skin having no side effects to human bodies. It has been also possible to reduce contaminated materials by removing unseen dust, minute particles and to use re-utilization materials. Besides, nano powder is applicable extensively to the fields of substitute energy and space aviation.

New characteristics of nano powder are shown by the increase in the specific surface area and change in electromagnetic properties in particles according to miniaturization of particles. In case of spherical particles, if it is assumed that the radius of an atom is d and the radius of a particle is r, the number of surface atoms is proportional to r²/d² and the number of inner atoms is proportional to r³/d³, and therefore, the ratio of the total number of atoms to the number of surface atoms is proportional to d/r. As the diameter of particles, i.e., size of particles, becomes smaller, the number of surface atoms is increased relatively, and accordingly, properties of nano particles are governed by surface properties as the size of nano particles becomes smaller. If the particle diameter is 1 μm, the specific surface area is about 1 m²/cc; and if the particle diameter is 0.01 μm (100 Å), the specific surface area is about 100 m²/cc. If they are converted in terms of the ratio of the number of atoms on the surface and the total number of atoms, the ratios would be 2×10⁻⁴ in case of 1 μm particles or 2×10⁻² in case of 0.01 μm particles assuming that the diameter of atoms is 2 Å. That is, the ratio of atoms on the surface is increased rapidly as the size of particles becomes close to the size of nano particles.

Accordingly, as mentioned in the above, since not only volumetric characteristics are decreased and surface characteristics are shown to be outstanding as the size of particles becomes smaller and the specific surface area becomes increased, but also new electromagnetic and optical properties are shown, demands for new industries applying nano particles are in an increasing trend.

In the meantime, the inventors of the present invention have conceived that the technology of automatic distribution or the equipment for automatic stabilization of nano metal powder, that have resolved all problems with the conventional methods of manufacture of nano powder but have not been found in other methods of manufacture, have been manipulated in one automatic line system, and invented equipment for the manufacture of nano powder equipped with the economic attribute that have not been comparable with other conventional methods of manufacture in the efficiency for energy and efficiency for production. These inventions have been published under PCT Laid-Open Patents No. 03/97521 and No. 03/70626.

Magnetic properties of materials are divided into strongly magnetic, weakly magnetic, and diamagnetic. Weakly magnetic materials are further divided into anti-ferromagnetic materials and paramagnetic materials. In case of paramagnetic materials, magnetic effects of electrons including spinning and orbital movements are offset each other exactly in most of atoms or ions making atoms or ions show no magnetic properties. This is shown in inactive gases such as neon, etc., or copper ions forming copper, etc. However, in some atoms or ions, magnetic effects of electrons are not offset completely, and all atoms have magnetic dipole moment.

If n atoms having magnetic dipole moment are put into a magnetic field, these atomic dipoles tend to be arranged in parallel in the direction of the magnetic field. This tendency is called paramagnetism. If all of these atomic dipoles are arranged in one direction completely, the overall dipole moment will be n μ. However, the process of arrangement is obstructed by heat movement. Already arranged state is broken as the collision occurs among atoms and kinetic energy is transmitted due to unmannerly vibration of atoms. How important heat movement is may be seen by comparing two types of energy: an average translational kinetic energy, (3/2) kT, of atoms at temperature T and energy difference, 2 μB, in two states of parallel and non-parallel to the direction of magnetic dipole magnetic field. The former is considerably greater than the latter at/in an ordinary temperature or magnetic field. Therefore, heat movement of atoms assumes a role of blocking arrangement of dipoles. The magnetic moment does not reach the maximum n μ at all although it is generated in the external magnetic field. In order to indicate the degree of magnetization of a material, magnetic moment per unit volume may be employed, which is called magnetization, M.

A material called a diamagnetic material has neither magnetic dipole of its own nor paramagnetism, but magnetic moment may be induced by the external magnetic field. Magnetic force is operated if samples of such material are placed near an uneven and strong magnetic field. However, contrary to an electric material, samples are pushed away, not drawn to the sides of electrodes of a magnet. Such difference between electricity and magnetism is because electric dipole induced is in the same direction as that of the external electric field, whereas magnetic dipole induced is in the opposite direction to that of the external magnetic field. Diamagnetism is a property in which Faraday's law of induction is applied to electrons in atoms, where the movement of electrons is a very small current chain from a classical point of view. The fact that the direction of the induced magnetic moment is opposite to that of the magnetic field is the result of Lenz's law in view of the scale of atoms.

Diamagnetism is a property of all atoms. However, if atoms have their own magnetic dipole moments, diamagnetic effects are shielded by stronger paramagnetism or ferromagnetism.

In the meantime, gold and silver are typical diamagnetic materials. That is, gold or silver powder shows magnetic properties in the opposite direction to that of the external magnetic field, and such diamagnetic characteristics are not known to be changed even if the size of gold or silver powder becomes equivalent to the size of nano particles. The dispersibility of gold or silver powder is also inferior due to a high cohesive force among particles making the fields of its application limited. Therefore, in the fields of application coming from the original characteristics of gold and silver, gold nano powder is simply used for nano gold soaps, sports lotions, cosmetics, beverages, semi-conductor luminous elements, drug transmitters, etc.; and silver nano powder is applicable to bio products such as cosmetics, fibers, pigments, plastics, etc., and anti-bacterial, germicidal, and anti-contaminant materials.

The inventors of the present invention have developed nano powder having paramagnetism which is a characteristic not owned by the conventional gold or silver nano particles. The above paramagnetic gold or silver powder has strong germicidal effects, and unique effects for increasing activities of various active components, that are not shown in the conventional diamagnetic gold or silver powder, and is characterized by having no cohesion property but a superior dispersibility.

It was confirmed that the effects for epilation were superior owing to the activation of germanium dioxide if paramagnetic silver was used along with germanium dioxide; if silver nano particles were added to toothpastes rather than adding the conventional diamagnetic silver particles, strong germicidal effects were shown, unique effects of increasing the activities of various active components contained in toothpaste compositions were shown, remarkable whitening effects were shown, the surface of teeth was shiny as there were no surface oxidation layers of the above paramagnetic silver and light scattering effects were superior, and there were operational effects of beautifying the appearance of teeth; and there were effects of increasing the activities of various active components contained in cosmetic compositions, promoting moisturizing effects of the skin, improving troubles of the skin, preventing the skin from being sticky, making the skin soft, and purifying the skin. The present invention was completed based on these findings.

### SUMMARY OF THE INVENTION

It is, therefore, an object of the present invention to provide with paramagnetic gold or silver powder having mass magnetism in the same direction as that of the external magnetic field, i.e., in the positive direction at all temperature ranges with respect to that the conventional gold or silver powder is diamagnetic, where the paramagnetic gold or silver powder according to the present invention shows an extremely small coercive force, has no surface oxidation layers, is unstable at a room temperature, and has no cohesion property, but a high dispersibility.

It is another object of the present invention to provide with an efficient method of manufacture of paramagnetic gold or silver powder according to the present invention.

It is still another object of the present invention to provide with epilation compositions containing paramagnetic silver and toothpaste compositions containing paramagnetic silver nano powder.

It is yet another object of the present invention to provide with cosmetic compositions containing paramagnetic gold, or silver, or their mixture.

Additional features and advantages of the present invention will be set forth in the description which follows, and in part will be apparent from the description, or may be learned by practice of the present invention. The objectives and other advantages of the present invention will be realized and attained by the process particularly pointed out in the written description and claims hereof, as well as the appended drawings.

The present invention is related to gold or silver powder characterized by having paramagnetism. In more detail, contrary to the conventional gold or silver powder known to be a diamagnetic material having magnetism in the opposite direction to that of the magnetic field in the external magnetic field, the gold or silver powder according to the present invention is characterized by being a paramagnetic gold or silver powder having magnetism in the same direction as that of the external magnetic field, i.e., in the positive direction, in all temperature ranges, which is further characterized by having saturated magnetic moment with the external magnetic field, H, of 2,000 to 8,000 Oe.

Further, the paramagnetic gold or silver powder according to the present invention is characterized by that inclination dM/dH of the mass magnetism curve is positive at an absolute temperature of 20 K with the external magnetic field, H, of greater than 1,000 Oe. Still further, the paramagnetic gold or silver powder according to the present invention shows an extremely small coercive force, has no surface oxidation layers, is stable at a room temperature, has no cohesive property, and is highly dispersible.

The paramagnetic gold or silver powder according to the present invention is illustrated in detail below:

The conventional gold or silver powder as a typical diamagnetic material having magnetism in the opposite direction to that of the magnetic field when the magnetic field is applied externally. It has been known that such diamagnetic characteristic has not been changed although the size of the gold or silver powder has become nano-sized, and the fields of its application have been limited due to inferior dispersibility coming from high cohesive properties among particles.

As shown in FIG. 1, the conventional silver powder has an increased mass magnetization, M, as the external magnetic field in the low magnetic field is increased. It is seen that mass magnetization is the highest at 2,000 Oe if the temperature of samples is 20 K, and is reduced as the magnetic field is increased in case of H>2,000 Oe (dM/dH<0). Near 4,000 Oe, mass magnetization has a value of “0,” and a negative value if the external magnetic field is H>4,000 Oe. The dependency on the magnetic field of the conventional silver powder shows a similar mode even when the temperatures of samples are 100 K and 300 K. Also, in cases of 100 K and 300 K, the phenomenon that, mass magnetization is increased as the magnetic field is increased in a low magnetic field, is considerably weakened; while the phenomenon that the value of mass magnetization is reduced along with the magnetic field in a high magnetic field region, is shown to be remarkable. That is, mass magnetization according to the change in the magnetic field is increased as the temperature is increased in a high magnetic field region of greater than H>2,000 Oe.

As shown in FIG. 2, the conventional gold powder also shows a trend that mass magnetization is rapidly increased as the magnetic field is increased in a low magnetic field (H<1,000 Oe), whereas inclination of mass magnetization curve is characterized by having a negative value (dM/dH<0) in a high magnetic field region of greater than H>1,000 Oe. These results of measurement show that the conventional gold and silver powders are diamagnetic materials.

In contrast, the gold or silver powder according to the present invention has paramagnetic characteristics having mass magnetization in the same direction as that of the external magnetic field, i.e., a positive mass magnetization, in all temperature ranges.

The size of paramagnetic gold or silver powder according to the present invention is not limited specially, but usually, paramagnetic characteristics are shown when the size of powder is in the range of less than 40 μm, and are shown significantly as the size of powder becomes smaller as the inclination of mass magnetization is shown to be varied according to the size of powder. Hollow-structured gold or silver particles of which insides are not filled in also show paramagnetic characteristics, and gold or silver powder according to the present invention shows paramagnetic characteristics in all temperature ranges below a room temperature although mass magnetization curves are shown to be varied according to the temperature of the powder. Also, the silver or gold powder according to the present invention shows a coercive force of less than 5 Gauss in the temperature range of a room temperature, particularly, an extremely small coercive force of less than 2 Gauss at a room temperature.

If the size of the silver powder according to the present invention is less than 20 μm, the silver powder shows super-paramagnetic characteristics below the absolute temperature of 100 K, the inclination of dM/dH of the mass magnetization curve of a positive value, and the inclination dM/dH of the mass magnetization curve of 3×10⁻⁷ emu/g·Oe at an absolute temperature of 20 K.

Further, whereas the conventional silver powder has an extremely small amount of mass magnetization when the absolute temperature is 20 K and the external magnetic field is lower than 4,000 Oe, or when the absolute temperature is 100 K and the external magnetic field is lower than 2000 Oe, the silver powder according to the present invention shows paramagnetic characteristics from the region where the external magnetic field is low to the region where the external magnetic field is as high as 20,000 Oe. It shows a rapidly increasing mass magnetization up to a specific magnetic field, i.e., a saturated magnetic field, shows dependency on a weak magnetic field in the magnetic field region of greater than the saturated magnetic field, and has a saturated magnetic moment when the external magnetic field, H, is 2,000 to 8,000 Oe.

Whereas the conventional gold powder shows the inclination dA/dH of the mass magnetization of a positive value when H is lower than 2,000 Oe, the paramagnetic gold powder according to the present invention shows the inclination dM/dH of the mass magnetization curve of a positive value in all external magnetic field ranges at temperature ranges of lower than a room temperature. Compared to the conventional gold powder, the paramagnetic gold powder according to the present invention shows a greater mass magnetization by about 10 to 100 times, particularly, the inclination dM/dH of the mass magnetization is greater than 4×10⁻⁶ at an absolute temperature of 20 K when the external magnetic field, H, is 10,000 Oe if the size of the gold powder is less than 1 μm.

Still further, whereas surface oxidation layers are observed in most cases of the conventional silver powder as seen in an SEM photograph of the conventional diamagnetic silver powder in FIG. 3, the paramagnetic gold or silver powder according to the present invention has no surface oxidation layers, is stable at a room temperature, and has no cohesive property but a high dispersibility as seen in TEM photographs in FIGS. 4 to 8.

Hereinafter, a method of manufacture of the paramagnetic gold or silver powder according to the present invention is illustrated.

The paramagnetic gold or silver powder according to the present invention was manufactured by using the equipment disclosed in PCT Patent Laid-Open Publications No. 03/97521 and No. 03/70626 mentioned in the above, whereas a brief diagram of the equipment for the manufacture of the paramagnetic gold or silver powder according to the present invention is shown in FIG. 9.

The method of manufacture of the paramagnetic gold or silver powder according to the present invention is comprised of the steps of:

1) generation of argon plasma having an absolute temperature of 4,000 to 200,000 K by using an RF power amplifier of 13.56 MHz and 5 to 50 kW and an inductive coupled plasma torch in a vacuum reaction tube;

2) production of gold or silver metal plasma by reacting argon plasma generated in the above and diamagnetic gold or silver powder; and

3) manufacture of paramagnetic gold or silver powder by cooling rapidly the gold or silver metal plasma gas thus produced below a room temperature under a vacuum in a nano powder collection equipment installed at the lower end of a plasma reaction furnace.

In the equipment for the manufacture of the high-purity paramagnetic gold or silver powder according to the present invention, RF power system (1) is connected to RF matching circuits of hybrid control-type matching system (2) through about 5 m RF transmission line, matching circuits are connected mechanically to the helical antenna of inductive coupled plasma torch (3) by means of 0.5 mm-thick, 20 mm-wide, and 400 mm-long to the maximum copper ribbon-type plates, and the above antenna is put to earth electrically by first class. The helical antenna should be cooled with low-conduction cooling water of the low-conduction-water cooling system (9). Viton O-ring seals are equipped with in order to maintain a vacuum of 10-5 torr by integrating all of the inductive coupled plasma torch (3), plasma reaction tube system (4), raw material injection system (6), and powder collection system (8) with vacuum exhaustion system (7). Particularly, RF is connected between (3) and (4), and between (3) and (6), by using Teflon disks that are longer than 10 mm to prevent a short to the earth through the walls of (3), (4), (6), and (8) so that plasma is not shown directly, and also, (3), (4), (6), and (8) are installed with cooling taken into consideration in order to prevent gases contaminated by heat transmission from coming out. All of (3), (4), (6), and (8) should be installed vertically since a free-falling injection method without using transfer gases is used in order not to have the transfer of raw material powder affect the quality of plasma to the maximum.

Raw material injection system (6) is connected to the reaction gas control system (5), vacuum gauge, reaction gas buffer tank of the reaction gas control system (5), and reaction gas flow control system.

Reaction tube system of the plasma reaction tube system (4) assumes a role of confining metal plasma, and stainless steel or glass is used for the system according to what is the material. Also, manual RF inductive elements (antennas) are installed at the inner and outer parts of the plasma reaction tube system (4) in order to control the temperature of metal plasma, where the position of manual elements (antennas) or the gaps among elements are controlled according to the granularity and appearance of the synthesized powder. The final liquid nitrogen heat exchange system (10) is installed inside of the vacuum of the bottom part of this reaction tube in order to control the granularity of the synthesized powder. A cooling system is equipped with enabling control of the temperature of cooling by using water, low-temperature nitrogen, or liquid nitrogen according to the material and the granularity of the material. It is connected through vacuum bonding with shrinkage during cooling taken into consideration in order to use liquid nitrogen.

Next to the liquid nitrogen heat-exchange system (10), the powder collection equipment of the powder collection system (8) is attached, which is consisted of a powder collection chamber and a metal collection filter. In some cases, the metal collection filter is manipulated to be cooled with liquid nitrogen, and available for re-use. The metal filter is manufactured with a stainless material selectively or in layers up to 100 to 2,300 meshes according to the type of the powder to be manufactured. The lower end of the collection equipment is constructed to be connected to a vacuum exhaustion device at a right angle.

Generally, about 40,000 to 200,000 K plasma, preferably, 40,000 to 60,000 K plasma is generated by using an inductive coupled plasma torch. The RF power amplifier used here is of 13.56 MHz 10 kW (˜50 kW) grade, and the degree of vacuum is adjusted to be about 1 torr when the temperature and density that are proper for the actual reaction are obtained by generating the plasma under the vacuum condition of 10⁻³ torr and increasing the amount of input of argon which is the reaction gas. Both of the single-type and double-type RF power amplifiers may be used. If it is of the single type, it is preferable to have an output of greater than 7 kW; and if it is of the double type, it is preferable that each is greater than 5 kW. In view of the efficiency for synthesis and control of material characteristics, it is preferable to use double-type RF power amplifier which is positioned on top and at the bottom of the plasma reactor or multiple-type RF power amplifier. It depends on the time of reaction with plasma, i.e., the time taken to become a metal plasma completely, according to the size of raw material powder to be used. And it is necessary to have centered plasma or hollow plasma according to each section in the reaction tube. The construction of plasma may be controlled by controlling the manual RF application elements with Yugawa-type, trapezoidal, or helical antenna, etc.

The size and shape of particles are controlled through a rapid heat exchange in vacuum after making raw materials be in the atomic or metallic plasma gas state completely by reacting the plasma thus generated with about 1 to 50 μm gold or silver raw material to be synthesized. In general cases, in order to maintain the size of particles to be smaller than 100 nm, the calorie of gold or silver should be exchanged within 500 msec, and the time for heat exchange should be shortened as the size of particles is smaller. It is necessary to control the time of heat exchange sequentially in order to control the shape of particles in vacuum according to what is the material. Various types of powder may be synthesized by controlling the gap of the manual RF antenna in the vacuum reaction tube in the array form. Particularly, desired-sized powder may be obtained by controlling variables such as the length of reaction flame in which plasma is formed, the time and temperature of rapid cooling of the gold or silver plasma gas, etc.

Also, paramagnetic silver according to the present invention has a fast absorption power to the skin, a good feeling when it is touched to the skin as it is not sticky, effects for epilation and prevention of hair loss when it is used along with germanium dioxide, superior anti-bacterial, germicidal, and anti-contamination effects, superior effects for making teeth look beautiful, and characteristics of beautifying the appearance of teeth by having their surface sparkling owing to scattering of light as there are no oxidation layers on the surface of the powder. And paramagnetic gold or silver according to the present invention is characterized by increasing the activity of active components of cosmetics, having a superior skin absorption property, having superior anti-bacterial effects, being proper for various sensitive skins, and improving skin troubles.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention.

In the drawings:

FIG. 1 is a graph showing how the conventional diamagnetic silver powder is dependent on the magnetic field;

FIG. 2 is a graph showing how the conventional diamagnetic gold powder is dependent on the magnetic field;

FIG. 3 is an SEM photograph of the conventional diamagnetic silver powder;

FIG. 4 is a TEM photograph of the paramagnetic silver powder according to the present invention (Ag white type, 1 to 40 μm);

FIG. 5 is TEM photographs of the paramagnetic silver powder according to the present invention (Ag gray type, 50 nm to 3 μm);

FIG. 6 is TEM photographs of the paramagnetic silver powder according to the present invention (Ag black type, 1 to 50 nm);

FIG. 7 is a TEM photograph of the paramagnetic silver powder according to the present invention (Ag hollow type, 1 to 500 μm);

FIG. 8 is TEM photographs of the paramagnetic gold powder according to the present invention (Au black type, 1 to 20 nm);

FIG. 9 is a brief diagram of the equipment for the manufacture of the paramagnetic gold or silver powder according to the present invention;

FIG. 10 is a graph showing how the paramagnetic silver powder manufactured in Preferred Embodiment 1 is dependent on the magnetic field;

FIG. 11 is a graph showing how the paramagnetic silver powder manufactured in Preferred Embodiment 2 is dependent on the magnetic field;

FIG. 12 is a graph showing how the paramagnetic silver powder manufactured in Preferred Embodiment 3 is dependent on the magnetic field;

FIG. 13 is a graph showing how the paramagnetic silver powder manufactured in Preferred Embodiment 4 is dependent on the magnetic field;

FIG. 14 is a graph showing how the conventional diamagnetic silver powder is dependent on the temperature;

FIG. 15 is a graph showing how the paramagnetic silver powder manufactured in Preferred Embodiment 1 is dependent on the temperature;

FIG. 16 is a graph showing how the paramagnetic silver powder manufactured in Preferred Embodiment 2 is dependent on the temperature;

FIG. 17 is a graph showing how the paramagnetic silver powder manufactured in Preferred Embodiment 3 is dependent on the temperature;

FIG. 18 is a graph showing how the paramagnetic silver powder manufactured in Preferred Embodiment 4 is dependent on the temperature;

FIG. 19 is a graph showing how the paramagnetic gold powder manufactured in Preferred Embodiment 5 is dependent on the magnetic field;

FIG. 20 is a graph showing how the conventional diamagnetic gold powder is dependent on the temperature; and

FIG. 21 is a graph showing how the paramagnetic gold powder manufactured in Preferred Embodiment 5 is dependent on the temperature.

### DESCRIPTION OF THE PREFERRED EMBODIMENTS OF THE INVENTION

The silver raw material powder used in the present invention has a purity of greater than 98%, is of spherical shape, has a size of 1 to 50 μm, and is manufactured in the atomizing and liquid reduction method or mechanical milling method. In contrast, the gold raw material powder used in the present invention has a purity of greater than 98%, is of spherical or thin-plated shape, has a size of 20 to 100 μm, and is manufactured in the atomizing and liquid reduction method or mechanical milling method.

### MANUFACTURING EXAMPLE 1

Argon plasma of 38,000 to 45,000 K (Tₘₐₓ=84,000 K) is generated under the vacuum condition of 10⁻³ torr by using an inductive coupled plasma torch, an RF power amplifier of 13.56 MHz to 10 kW grade (7 kW or greater in case of single type, or 5 kW or greater per amplifier in case of double type for an RF power amplifier), and an RF power application element of the helical antenna. When the temperature exceeds 30,000 K, which is a proper temperature for the actual reaction, and the density of argon plasma exceeds 4×10¹¹ g/cm³, the degree of vacuum should be adjusted to be about 1 torr by increasing the amount of input of argon (99.999% pure), which is a reaction gas. The length of the reaction flame in which the plasma generated is formed is adjusted to be 600 to 700 mm and reacted with the silver raw material powder. After the raw material powder becomes in the atomic or metallic plasma gas state completely, spherical paramagnetic Ag white type powder having the size of 1 to 40 μm is obtained by cooling in water through a rapid heat exchange at 20 to 30° C. for 2 to 5 seconds under the vacuum condition. As shown in FIG. 4 which is the TEM photograph of the white silver powder obtained, no oxidation layers exist on the surface of silver powder. Also, the surface has a very precise nano-sized structure.

### MANUFACTURING EXAMPLE 2

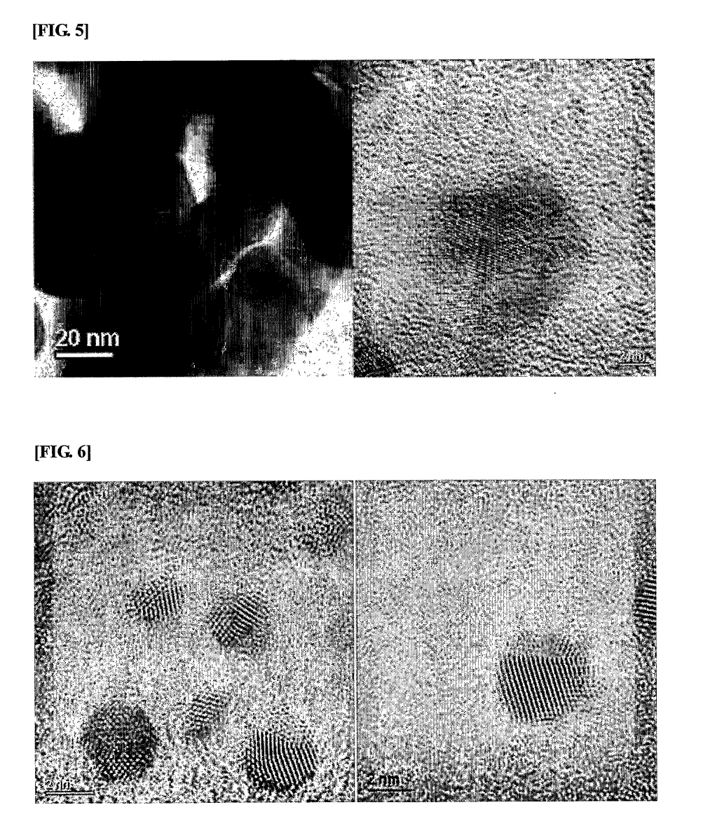

The length of the reaction flame in which plasma is formed is adjusted to be 300 to 400 mm. After the metallic plasma becomes in the gas state, spherical paramagnetic gray silver powder (Ag gray type) having a size of 50 nm to 3 μm is obtained under the same conditions for manufacture as those of Manufacturing Example 1 except that cooling is done in liquid nitrogen at −50 to −100° C. for 0.5 to 1 second under the vacuum condition. As shown in FIG. 5, which is the TEM photograph of the gray silver powder obtained, no oxidation layers exist on the surface of silver powder.

### MANUFACTURING EXAMPLE 3

The length of the reaction flame in which the plasma is formed is adjusted to be 250 to 300 mm by using two manual RF application elements of the trapezoidal antenna in the reaction tube. After the raw material powder becomes in the metallic plasma gas state, spherical paramagnetic black silver powder (Ag black type) having a size of 1 to 50 nm is obtained under the same conditions for manufacture as those of Manufacturing Example 1 except that cooling is done in liquid nitrogen below −100° C. for 0.1 to 0.3 seconds under the vacuum condition. As shown in FIG. 6, which is the TEM photograph of the black silver powder obtained, no oxidation layers exist on the surface of silver powder. And powder particles are not shown to be cohesive, but are dispersed well in distilled water, ethanol, methanol, etc.

### MANUFACTURING EXAMPLE 4

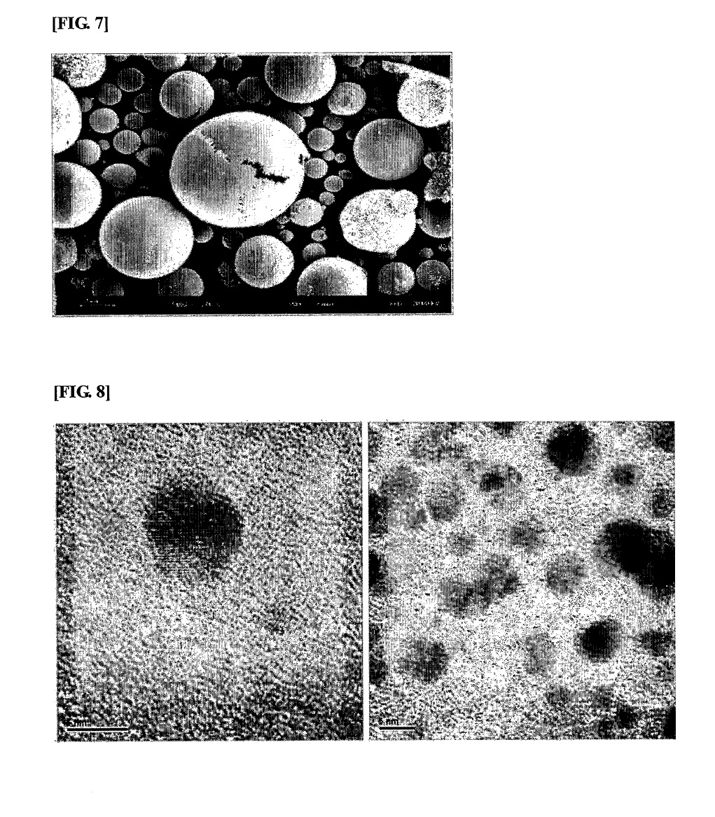

The length of the reaction flame in which the plasma is formed is adjusted to be 1,200 to 1,500 mm by using four manual RF application elements of the Yugawa-type antenna outside of the reaction tube. After the raw material powder becomes in the metallic plasma gas state, paramagnetic hollow silver powder (Ag hollow type) having a size of 1 to 500 μm is obtained under the same conditions as those of Manufacturing Example 1 except that 1 to 50 nm powder manufactured primarily (obtained in Preferred Embodiment 3) is used for the raw material powder instead of the silver raw material powder and cooling is done in water at 20 to 30° C. for 2 to 5 seconds. As shown in FIG. 7, which is the TEM photograph of the spherical silver powder obtained, no oxidation layers exist on the surface of silver powder. And it is seen that the spherical surface is comprised of individual silver particles, and the inside of the sphere is of hollow type.

### MANUFACTURING EXAMPLE 5

Spherical paramagnetic black gold powder (Au black type) having a size of 1 to 20 nm is obtained by using spherical and thin-plated 20 to 100 μm gold raw material powder having a purity of higher than 98% for the raw material, using argon gas having a purity of 99.999% for the reaction gas, at the plasma temperature of 40,000 to 60,000 K (Tₘₐₓ=84,000 K), using 8 kW or greater for the single-type RF applied power or 6 kW or greater each of up and down for the double-type RF applied power, adjusting the length of the reaction flame in which plasma is formed to be 20 to 30 mm, and cooling in liquid nitrogen below −100° C. for 0.1 to 0.3 seconds for the variables for the heat exchange process. As shown in FIG. 8, which is the TEM photograph of the gold powder obtained, no oxidation layers exist on the surface of silver powder. And powder particles are not cohesive even at a room temperature, but are dispersed well in distilled water, ethanol, etc.

### PREFERRED EMBODIMENT 1

In order to compare and analyze magnetic properties of the paramagnetic silver powder manufactured in Manufacturing Examples 1 through 4 and the conventional diamagnetic silver powder (raw material silver powder), mass magnetization is measured by using Magnetic Property Measurement System (MPMS-XL, Quantum Design) while changing the temperature and magnetic field.

Experiments for the dependency on magnetic field are performed at absolute temperatures of 20 K, 100 K, and 300 K; whereas experiments for the dependency on temperature are performed under the condition that the external magnetic field, H=10,000 Oe.

In order to extract only the magnetic moment coming from the powder, data are obtained by deducting the magnetic moment of diamagnetic capsules of each powder from the measured value of each powder.

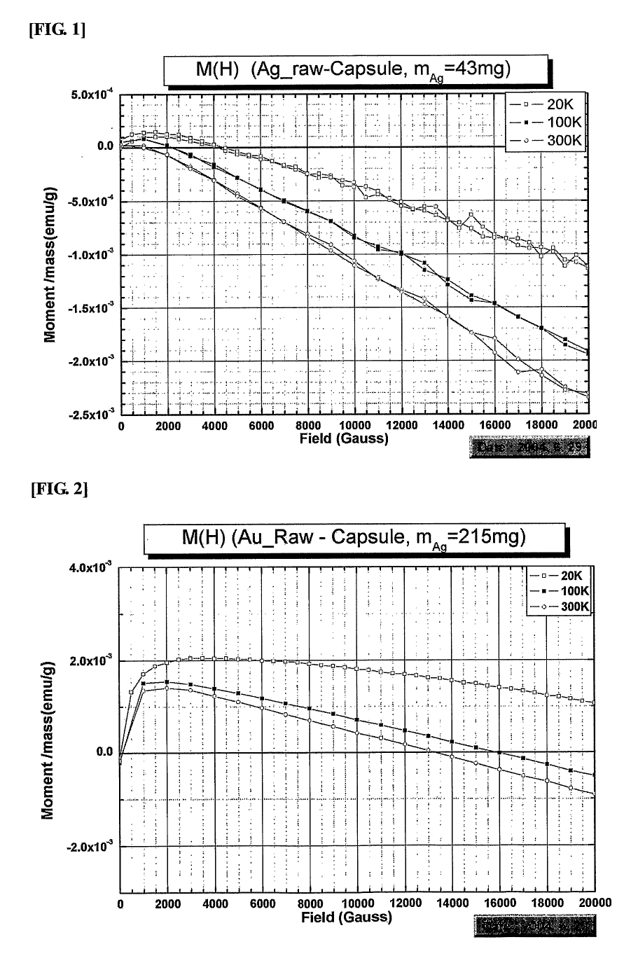

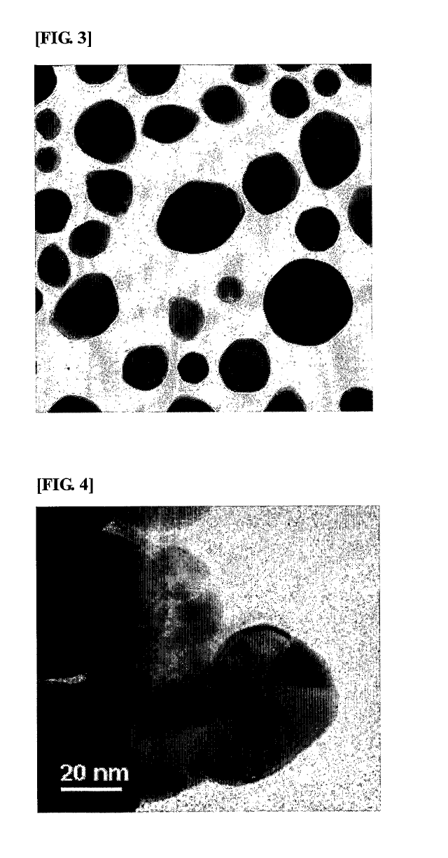

As seen in FIG. 1, the mass magnetization, M, of the raw material silver powder is increased as the external magnetic field is increased in a low magnetic field, is the maximum at 2,000 Oe if the temperature of samples is the absolute temperature of 20 K, and is decreased as the magnetic field is increased in case of H>2,000 Oe (dM/dH<0). Near 4,000 Oe, the mass magnetization has a value of “0,” and has a negative value if the external magnetic field, H>4,000 Oe. And the dependency on the magnetic field shows a similar behavior even when the temperatures of samples are 100 K and 300 K.

In cases of 100 K and 300 K, the phenomenon that the mass magnetization is increased as the magnetic field is increased in a low magnetic field is considerably weakened, but the phenomenon that the mass magnetization is reduced along with the magnetic field in a high magnetic field region is shown to be remarkable. That is, the rate of change of the mass magnetization according to the change in magnetic field is increased as the temperature is increased in a high magnetic field region of higher than H>2,000 Oe, and the value of mass magnetization measured while increasing the external magnetic field and that measured while reducing the external magnetic field are the same. Further, there are no hysteresis characteristics observed.

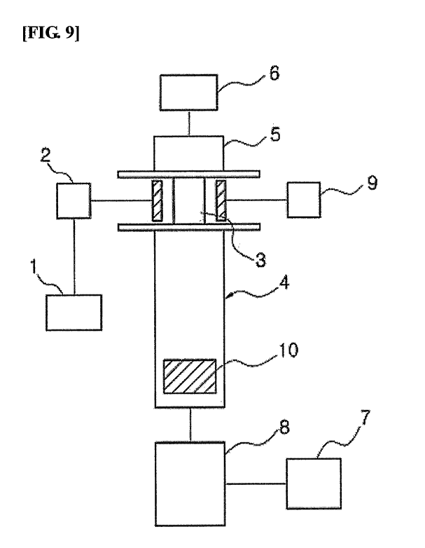

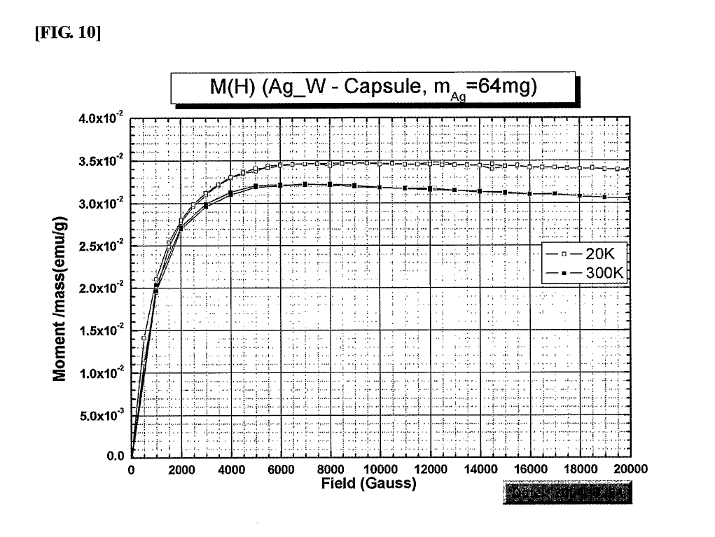

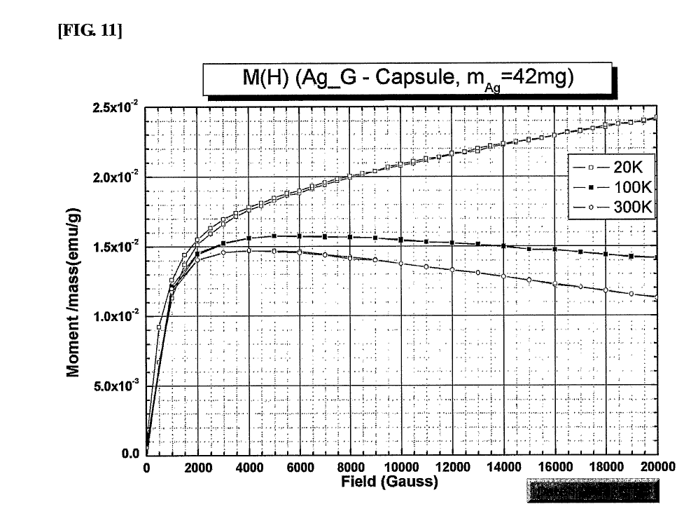

Raw material silver powder shows diamagnetic characteristics in which the mass magnetization is reduced as the external magnetic field is increased in all magnetic field regions excluding low magnetic field regions (H<2,000 Oe). In high magnetic field regions of H>4,000 Oe, whereas the mass magnetization has a negative value, all of Ag white type, Ag gray type, and Ag black type manufactured in Manufacturing Examples 1 through 3 show a rapidly increasing mass magnetization up to a specific magnetic field (saturated magnetic field), and thereafter, a weak dependency on the magnetic field in magnetic field regions higher than saturated magnetic fields as seen in FIGS. 9 through 11.

In other words, at an absolute temperature of 20 K and in a high magnetic field region of higher than a saturated magnetic field, the inclination of the mass magnetization curve shows a negative value smaller than “0” (dM/dH<0) in case of a silver raw material. On the other hand, in case of the Ag white type, the inclination of the mass magnetization shows almost no dependency on the magnetic field, but has a positive value greater than “0” (dM/dH>0) of Ag gray type and Ag black type compared to the value of mass magnetization.

Ag hollow type also shows a tendency that mass magnetization is increased rapidly as the magnetic field is increased in low magnetic fields, but is reduced a little as the magnetic field is increased in high magnetic fields higher than the saturated magnetic field of about H=4,000 Oe.

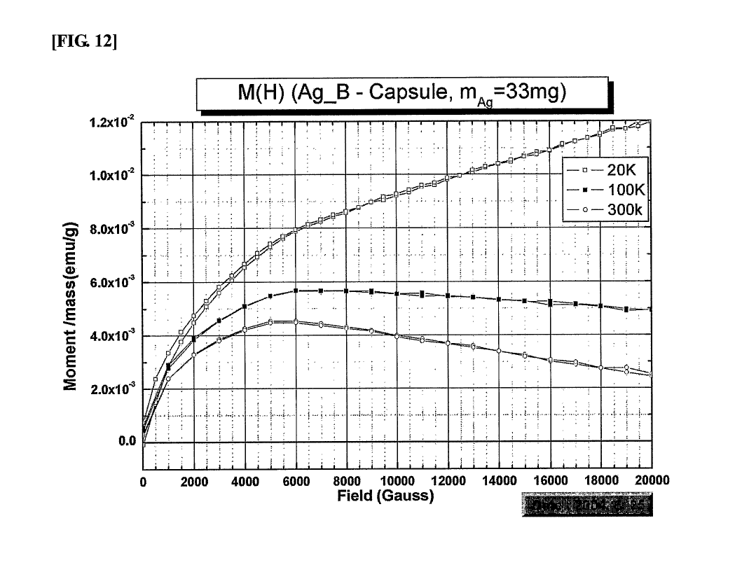

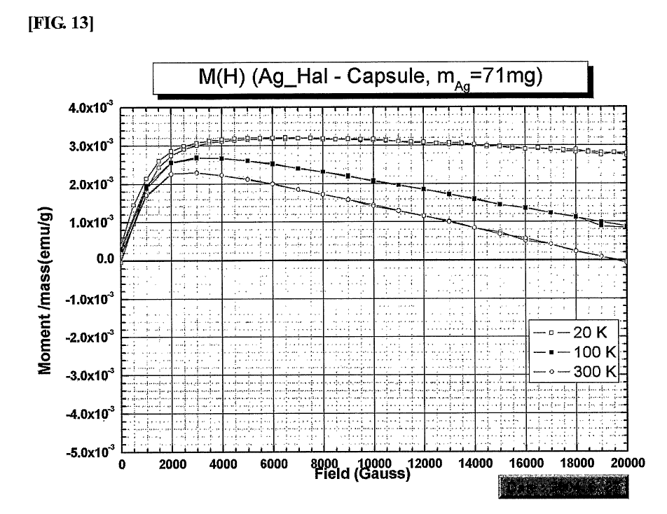

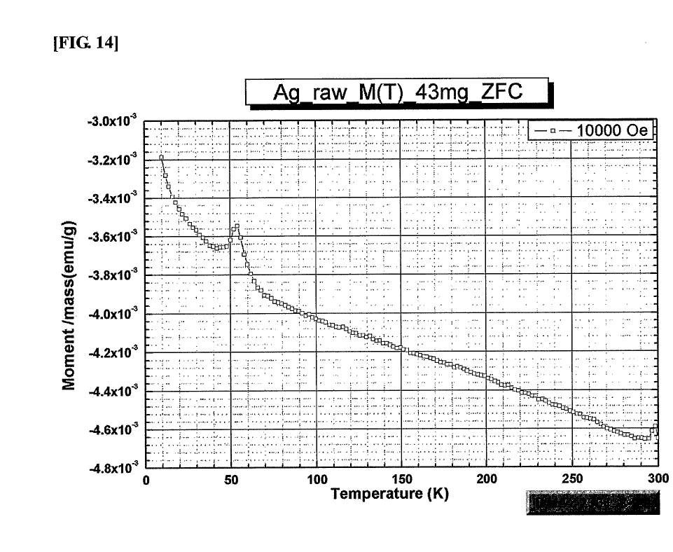

Further, FIGS. 10 through 13 and 19 show magnetic properties when the magnetic field is increased and when it is decreased. It is seen that an extremely small coercive force of lower than 5 Gauss is shown and there is almost no coercive force in a part of cases in that the coercive force is lower than 2 Gauss. This implies that the gold or silver powder according to the present invention returns to the original state without loss of magnetic force when the external magnetic field is applied to and the magnetic field is removed, which further implies that paramagnetic materials according to the present invention may be applied to semi-conductor elements.

Saturated magnetic field values of each powder in Manufacturing Examples 1 through 3 and the maximum size of mass magnetization are shown in Table 1. And inclination of the linear portion of the mass magnetization in the regions higher than the saturated magnetic field is shown in Table 2.

TABLE 1

| | 20K | | 300K | |
|---|---|---|---|---|
| | Saturated | | Saturated | |
| | magnetic | Maximum mass | magnetic | Maximum mass |
| | field | magnetization | field | magnetization |
| | (Oe) | (emu/g) | (Oe) | (emu/g) |
| White | 7,500 | 3.46 × 10⁻² | 6,000 | 3.22 × 10⁻³ |
| Gray | 5,500 | — | 5,000 | 1.47 × 10⁻² |
| Black | 6,000 | — | 6,000 | 4.47 × 10⁻³ |

TABLE 2

| | 20K (emu/g Oe) | 300K (emu/g Oe) |
|---|---|---|
| Raw | −7.28 × 10⁻⁸ | −1.27 × 10⁻⁷ |
| White | −6.02 × 10⁻⁸ | −1.37 × 10⁻⁷ |
| Gray | 3.63 × 10⁻⁷ | −2.37 × 10⁻⁷ |
| Black | 2.84 × 10⁻⁷ | −1.43 × 10⁻⁷ |

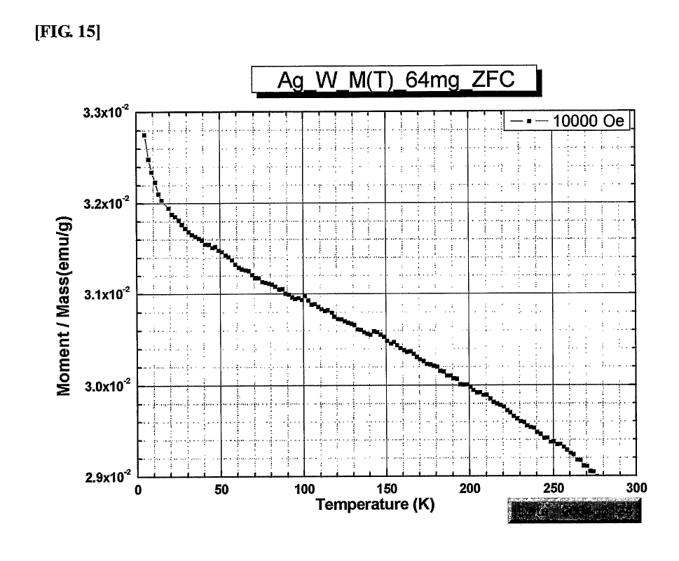

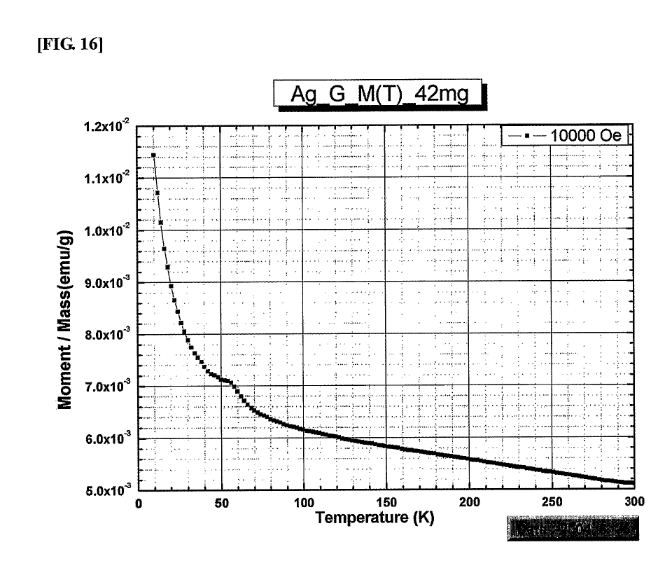

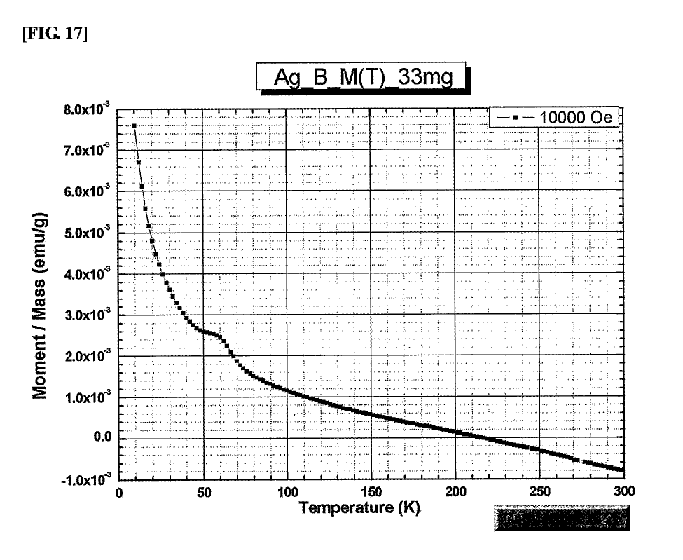

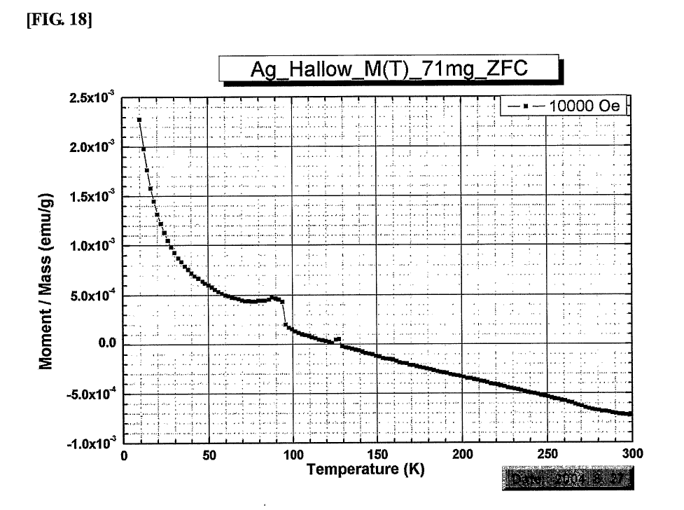

As seen in FIGS. 15 through 18, the results of experiments for the dependency on temperature show the same meaning as the results of dependency on magnetic field mentioned in the above. That is, the absolute value of mass magnetization is shown to be reduced as the temperature is increased when the external magnetic field of 1 Tesla is applied to, and only the mass magnetization of the raw material silver powder has a negative value in all temperature ranges. Ag white type, Ag gray type, and Ag black type powders including Ag hollow type have positive mass magnetization values in all temperature ranges if the capsule effect, characterized by having mass magnetization of smaller than “0,” is removed.

### PREFERRED EMBODIMENT 2

Magnetic properties of the paramagnetic gold powder according to the present invention manufactured in Manufacturing Example 5 and of the conventional diamagnetic gold powder (raw material gold powder) are compared and analyzed under the same conditions as those of Preferred Embodiment 1.

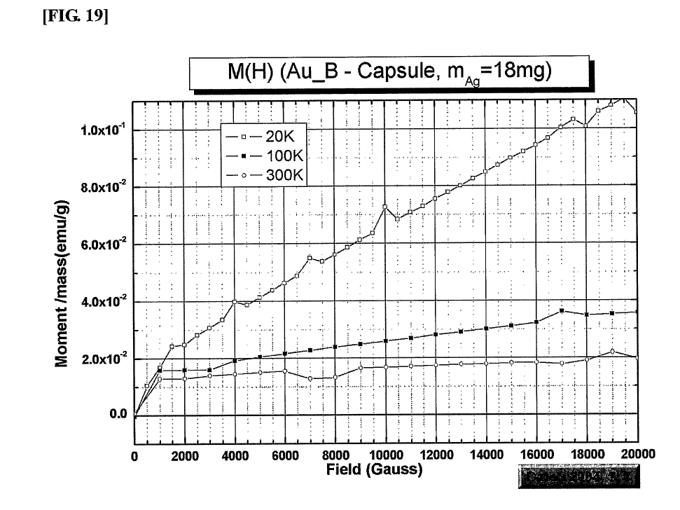

As shown in FIGS. 4 and 19, both of the gold raw material and the gold powder according to the present invention manufactured in Manufacturing Example 5 shows a tendency that mass magnetization is rapidly increased as the magnetic field is increased in low magnetic fields (H<1,000 Oe), but in high magnetic field regions of higher than H>1,000 Oe, whereas the inclination of the mass magnetization curve of the gold raw material has a negative value (dM/dH<0), that of Au black type has a positive value (dM/dH>0). Au black type of Preferred Embodiment 5 has an about 10 to 100 times greater mass magnetization value according to the magnitude of the magnetic field compared to that of the raw material gold powder. Table 3 shows inclinations of the linear portion of mass magnetization curves of the gold raw material and Au black type.

TABLE 3

| | 20K (emu/g Oe) | 300K (emu/g Oe) |
|---|---|---|
| Raw | −8.60 × 10⁻⁸ | −1.34 × 10⁻⁷ |
| Black | 4.35 × 10⁻⁶ | 3.55 × 10⁻⁷ |

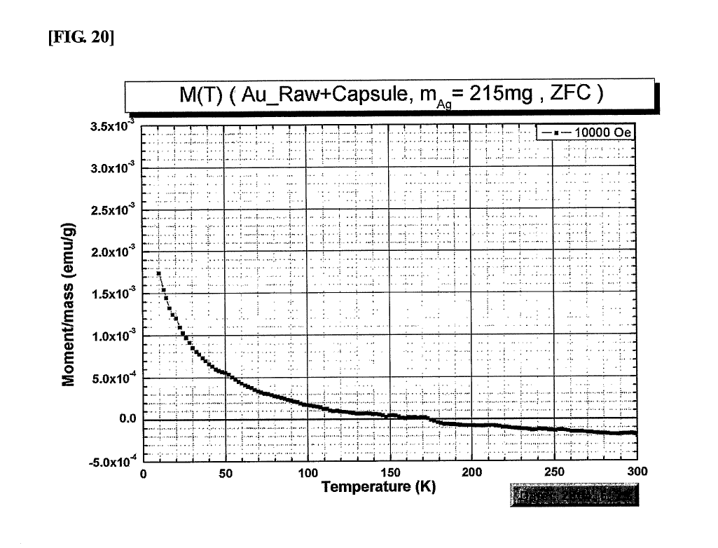

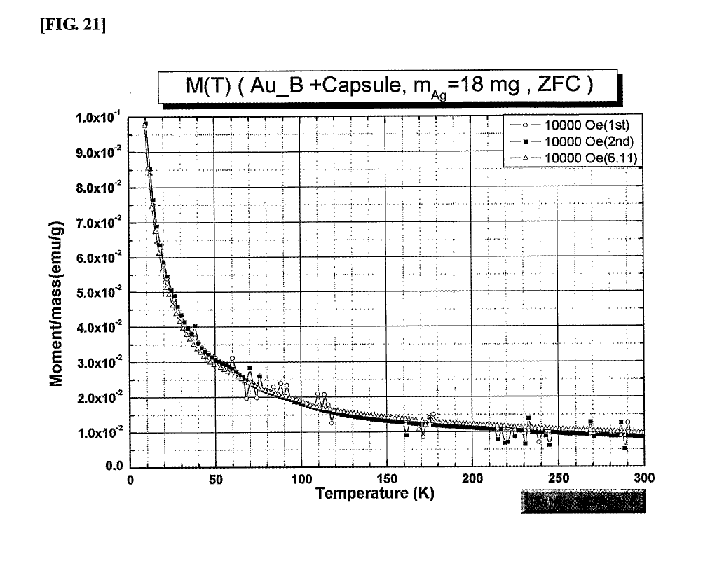

As a result of measurement for the analysis of dependency on temperature in the magnetic field of H=10,000 Oe, as shown in FIGS. 19 and 20, it is seen that the conventional gold powder has positive mass magnetization values in all temperature ranges if capsule effect, characterized by having mass magnetization values of smaller than “0,” is removed. These results of experiments for the dependency on temperature have the same meaning as the results of dependency on magnetic field described in the above. That is, it is seen that mass magnetization is shown to be reduced as the temperature is increased when the external magnetic field of 1 Tesla is applied to, while Au black type has an about 100 times greater mass magnetization value in all temperature ranges when the external magnetic field of 1 Tesla is applied to compared to the conventional gold raw material powder.

### PREFERRED EMBODIMENTS 3 THROUGH 5

Manufacture of Epilation Agent Compositions

The magnetic silver nano powder manufactured according to the method described in Manufacturing Example 3 is used for the paramagnetic silver nano powder to be added. Germanium dioxide included in epilation agent compositions according to the present invention is a natural organic lignite extract. High-purity lignite powder obtained through high-temperature combustion in a 1,600 to 2,000° C. combustion furnace and washing with water of lignite is dissolved to have a concentration of 3 to 200 ppm.

Epilation agent compositions are manufactured by dissolving each component at 21° C. by using the components and mixing ratios shown in the following Table 4. The epilation agent compositions thus manufactured are colorless and transparent, and has a pH of 7.76.

TABLE 4

| | Preferred | | Preferred | | Preferred | |
|---|---|---|---|---|---|---|
| | Embodiment | | Embodiment | | Embodiment | |
| Component | 3 | | 4 | | 5 | |
| Paramagnetic silver | 0.1 | ppm | 0.3 | ppm | 0.5 | ppm |
| nano particles | | | | | | |
| Germanium dioxide | 30 | ppm | 30 | ppm | 30 | ppm |
| Sucrose | — | | 10 | g | 10 | g |
| Ethanol | — | | 100 | ml | 100 | ml |
| Purified water | 1,000 | ml | 900 | ml | 900 | ml |

### COMPARATIVE EXAMPLE 1

Compositions are manufactured with the paramagnetic silver nano powder and germanium dioxide omitted from the compositions in the above Preferred Embodiments 3 through 5.

### TESTING EXAMPLE 1

Epilation Effect Experiments

Effects for epilation are measured for 15 patients of various hair-losing diseases in their thirties to sixties. Effects of epilation are evaluated by applying the epilation agent compositions manufactured in Preferred Embodiments 3 through 5 and the compositions in Comparative Example 1 not containing silver nano particles and germanium dioxide to the scalp of each patient. Administration of these compositions to the scalp is performed three times a day for 4 months, and the state of hair growth is evaluated after 4 months. The criteria for evaluation are as follows: 1. Highly effective—newly grown hair (strong hair); 2. Intermediately effective—newly grown hair (downy hair); 3. A little effective—reduced number of hair loss; and 4. Not effective. The results of tests are shown in Table 5.

TABLE 5

| | Preferred | Preferred | Preferred | |
|---|---|---|---|---|
| Evaluation | Embodi- | Embodi- | Embodi- | Comparative |
| criteria | ment 3 | ment 4 | ment 5 | Example 1 |
| Strong hair | 5 | 7 | 9 | 0 |
| Downy hair | 7 | 5 | 4 | 0 |
| Reduced hair loss | 2 | 2 | 1 | 2 |
| No effects | 2 | 1 | 1 | 13 |

Table 5 shows that epilation agent compositions in Preferred Embodiments 3 through 5 containing paramagnetic silver nano particles and germanium dioxide have superior epilation effects, but it is confirmed that the compositions in Comparative Example 1 not containing silver nano particles and germanium dioxide show none of significant epilation effects.

Particularly, the compositions in Preferred Embodiment 5 containing a large amount of paramagnetic silver nano particles as well as saccharides show the best epilation effects, and newly born downy hairs or strong hairs begin to grow from the first or second month, and the effect of regeneration of hairs are shown in 13 patients among 15 patients from the fourth month. It is, therefore, confirmed that the epilation agents according to the present invention activate hair follicles shrunk by the immunity reinforcement actions of paramagnetic silver nano particles and germanium dioxide, and thus, regenerate hair follicles. It is expected that they bring about superior effects for the acceleration of epilation and prevention of hair loss for the patients of hair loss eventually.

### PREFERRED EMBODIMENTS 6 AND 7

Toothpaste Compositions

Toothpaste compositions are manufactured according to the components and mixing ratios shown in the following Table 6 by using the paramagnetic silver nano particles manufactured according to the method described in Manufacturing Example 3 for the paramagnetic silver nano particles to be added:

TABLE 6

| | | Preferred | Preferred |
|---|---|---|---|
| | | Embodi- | Embodi- |
| Component (wt %) | | ment 6 | ment 7 |
| Silver nano particles | | 0.015 | 0.02 |
| Abrasive | Silicon dioxide | 10 | 10 |
| Moisturizing agents | Sorbitol | 60 | 60 |
| | PEG1500 | 2.0 | 2.0 |
| Binder | Cellulose gum | 0.70 | 0.70 |
| Bubbling agent | Sodium lauryl sulfate | 2.20 | 2.20 |
| Fluoride | Sodium fluorophosphate | 0.75 | 0.75 |
| Fragrances | L-mentol | 0.10 | 0.10 |
| | Eucalyptol | 0.05 | 0.05 |
| Sweetening agent | Xylitol | 0.12 | 0.12 |
| Viscosity promotor | Hydroxylated silica | 9 | 9 |
| Hemostat | Aminocaproic acid | 0.09 | 0.09 |
| Tartar formation | Sodium pyrophosphate | 0.5 | 0.5 |
| suppressant | | | |
| Whitening agent | Titanium oxide | 0.30 | 0.30 |

| | | |
|---|---|---|
| Flavor | 0.1 | 0.1 |
| Purified water | 14.08 | 14.07 |

### COMPARATIVE EXAMPLE 2

Toothpaste Compositions

Toothpaste compositions are manufactured in the same method as those of Preferred Embodiments 6 and 7 except that no silver nano particles are contained.

### COMPARATIVE EXAMPLE 3

Toothpaste Compositions

Toothpaste compositions containing the conventional silver particles are manufactured according to the components and mixing ratios shown in the following Table 7.

TABLE 7

| Component (wt %) | Comparative Example 3 |
|---|---|
| Colloidal silicon dioxide | 5 |
| Sorbitol | 60 |
| Glycerin | 10 |
| Xylitol | 0.5 |
| Aminocaproic acid | 0.2 |
| Allantoin chlorohydroxy aluminum | 0.1 |
| salt | 5 |
| Silver particles | 1 |
| Purified water | 18.2 |

### EXPERIMENTAL EXAMPLE 2

Anti-Bacterial Effects of Toothpaste Compositions According to the Present Invention

Minimum inhibitory concentration (MIC) is measured in order to study anti-bacterial actions of toothpaste compositions containing silver nano particles of the present invention for caries bacteria and bacteria causing periodontal diseases.

Anti-bacterial power is evaluated in the agar culture medium dilution method by using brain heart infusion agar (BHIA) containing CPC in each concentration.

MIC measurement is done after culturing at 38° C. under the condition of 5% CO₂ for 7 days in case of the bacteria causing periodontal diseases, or after culturing at 38° C. under the aerobic condition for 3 days in case of the bacteria causing caries.

Anti-bacterial power is evaluated in the agar culture medium dilution method by using BHIA containing the components in Preferred Embodiments 6 and 7 and Comparative Example 2 and 3 in each concentration. Tests are performed with concentrations diluted in 10 steps in total by diluting testing toothpaste compositions 50 times to 2 times.

The results of the MIC measurement are shown in the following Table 8:

(1) Tested bacteria
1) Bacteria causing periodontal diseases: Actionbacillus actinomycetemcomitans, Fusobacterium nucleatum
2) Bacteria causing caries: Streptococcus mutans, Actinomyces viscosus

(2) Culture medium used

Blood agar culture medium (blood agar base+blood in an amount of 5% of the final concentration) BHI agar

TABLE 8

| | | Preferred | Preferred | Comparative | Comparative |
|---|---|---|---|---|---|
| | | Embodiment 6 | Embodiment 7 | Example 2 | Example 3 |
| | | (Dilution | (Dilution | (Dilution | (Dilution |
| Tested bacteria | MIC | multiple) | multiple) | multiple) | multiple) |
| Actionbacillus | 7 | 200 | 200 | 100 | 100 |
| actinomycetemcomitans | | | | | |
| Fusobacterium nucleatum | 2.5 | 800 | 400 | 100 | 200 |
| Streptococcus mutans | 0.5 | 800 | 800 | 200 | 400 |
| Actinomyces viscosus | 2.5 | 800 | 800 | 200 | 400 |

As shown in Table 8, it is shown that MIC for showing the anti-bacterial power of each test tube is 0.5 to 7 μg/ml, and the compositions in Preferred Embodiments 6 and 7 of the present invention show two times greater anti-bacterial power in experimental strains compared to the compositions not containing silver nano particles in Comparative Example 2 and toothpaste compositions containing the conventional diamagnetic silver nano particles in Comparative Example 3. Also, the compositions in Preferred Embodiment 6 having a greater amount of silver nano particles show a better anti-bacterial power against Fusobacterium nucleatum compared to the compositions in Preferred Embodiment 7. It is, therefore, seen that toothpaste compositions according to the present invention have a superior anti-bacterial power as they contain paramagnetic silver nano particles.

### TESTING EXAMPLE 3

Evaluation of Whitening Effects of Toothpaste Compositions According to the Present Invention

In order to look into the sense of beauty and touch and the effect of shining of the toothpaste compositions according to the present invention, the toothpaste compositions in Preferred Embodiment 6 and Comparative Examples 2 and 3 are offered to 40 male and female subjects who are older than 10 years old and the above effects are evaluated based on blind tests. The results of evaluation are shown in the following Table 9:

TABLE 9

| | Preferred | Comparative | Comparative |
|---|---|---|---|
| | Embodiment 6 | Example 2 | Example 3 |
| | (Number | (Number | (Number |
| | of people | of people | of people |
| Characteristics | responded) | responded) | responded) |
| Best feeling of | 31 | 3 | 6 |
| beauty | | | |
| Best feeling of | 28 | 5 | 7 |
| touch | | | |
| Best shining of | 35 | 1 | 4 |
| teeth | | | |

It is shown from the results of Table 9 that the toothpaste compositions in Preferred Embodiment 6 containing the paramagnetic silver nano particles according to the present invention have better feeling of beauty and touch, and shining of teeth compared to the compositions in Comparative Examples 2 and 3 containing no silver or containing the conventional diamagnetic silver particles. Particularly, as to shining of teeth, most people responded show the reaction that the compositions according to the present invention are better. It is, therefore, confirmed that the toothpaste compositions according to the present invention make the surface gloss of teeth improved as they use paramagnetic silver having no surface oxidation layers, and thus, light scattering effects are superior.

### PREFERRED EMBODIMENT 8

Essences Containing Wrinkle Improving Agents

Essences are manufactured according to the components and mixing ratios shown in the following Table 10 by using the paramagnetic silver nano particles manufactured according to the method described in Manufacturing Example 3 for the paramagnetic silver nano particles to be added and using the paramagnetic gold nano particles manufactured under the conditions described in Manufacturing Example 5 for the paramagnetic gold nano particles:

TABLE 10

| Component | Content (wt %) |
|---|---|
| Purified water | Rest |
| Sitosterol | 1.70 |
| Polyglyceryl 2-oleate | 1.50 |
| Ceramide | 0.7 |
| Ceteareth-4 | 1.2 |
| Cholesterol | 1.5 |
| Dicetyl phosphate | 0.4 |
| Concentrated glycerin | 5.0 |
| Sunflower oil | 15.0 |
| Carboxyvinyl polymer | 0.2 |
| Xanthan gum | 0.2 |
| Antiseptic | Small amount |
| Fragrance | Small amount |
| Ag nano particles | 30 ppm |
| Au nano particles | 10 ppm |

### PREFERRED EMBODIMENT 9

Skin Lotions

Skin lotions are manufactured according to the components and mixing ratios shown in the following Table 11 by using the paramagnetic silver nano particles manufactured according to the method described in Manufacturing Example 3 for the paramagnetic silver nano particles to be added and using the paramagnetic gold nano particles manufactured under the conditions described in Manufacturing Example 5 for the paramagnetic gold nano particles:

TABLE 11

| Component | Content (wt %) |
|---|---|
| Purified water | Rest |
| Trehalose | 3.0 |
| Concentrated glycerin | 3.0 |
| Ethanol | 3.0 |
| Butylene glycol | 2.0 |
| Polyoxyethylene hardened castor oil | 0.3 |
| Phenyltrimethicone | 0.15 |
| Carboxy vinyl polymer | 0.08 |
| Triethanol amine | 0.05 |
| Ethylenediamine sodium tetraacetate | 0.02 |
| Fragrance | Proper amount |
| Ag nano particles | 30 ppm |

### PREFERRED EMBODIMENT 10

Nutritional Toners

Nutritional toners are manufactured according to the components and mixing ratios shown in the following Table 12 by using the paramagnetic silver nano particles manufactured according to the method described in Manufacturing Example 3 for the paramagnetic silver nano particles to be added.

TABLE 12

| Component | Content (wt %) |
|---|---|
| Purified water | Rest |
| Liquid paraffin | 5.0 |
| Tri(capric, caproic acid) glycerin | 5.0 |
| Cetyl octanoate | 5.0 |
| Concentrated glycerin | 3.0 |
| Polyglyceryl-3-methylglucose distearate | 2.0 |
| Cyclomethicone | 2.0 |
| Dimethicone | 1.0 |
| Stearic acid | 0.8 |
| Cetostearyl alcohol | 0.7 |
| Lipophilic monostearic acid glycerin | 0.6 |
| Triethanol amine | 0.2 |
| Carboxy vinyl polymer | 0.15 |
| Ethylenediamine sodium tetraacetate | 0.02 |
| Fragrance | Proper amount |
| Ag nano particles | 30 ppm |

### PREFERRED EMBODIMENT 11

Creams

Creams are manufactured according to the components and mixing ratios shown in the following Table 13 by using the paramagnetic silver nano particles manufactured according to the method described in Manufacturing Example 3 for the paramagnetic silver nano particles to be added and using the paramagnetic gold nano particles manufactured under the conditions described in Manufacturing Example 5 for the paramagnetic gold nano particles:

TABLE 13

| Component | Content (wt %) |
|---|---|
| Purified water | Rest |
| Liquid paraffin | 10.0 |
| Concentrated glycerin | 7.0 |
| Tri(capric, caproic acid) glycerin | 5.0 |
| Cetyl octanoate | 5.0 |
| Cyclomethicone | 5.0 |
| Propylene glycol | 5.0 |
| Vaseline | 3.0 |
| Stearic acid | 2.0 |
| Cetostearyl alcohol | 2.0 |
| Lipophilic monostearic acid glycerin | 2.0 |
| Triethanol amine | 0.2 |
| Monostearic acid polyoxyethylsorbitan | 1.5 |
| Dimethicone | 1.0 |
| Sesquioleic acid sorbitan | 0.8 |
| Ethylenediamine sodium tetraacetate | 0.02 |
| Fragrance | Proper amount |
| Ag nano particles | 25 ppm |
| Au nano particles | 10 ppm |

### PREFERRED EMBODIMENT 12

Packs

Packs are manufactured according to the components and mixing ratios shown in the following Table 14 by using the paramagnetic silver nano particles manufactured according to the method described in Manufacturing Example 3 for the paramagnetic silver nano particles to be added and using the paramagnetic gold nano particles manufactured under the conditions described in Manufacturing Example 5 for the paramagnetic gold nano particles:

TABLE 14

| Component | Content (wt %) |
|---|---|
| Purified water | Rest |
| Poly(vinyl alcohol) | 15.0 |
| Ethanol | 5.0 |
| Concentrated glycerin | 2.0 |
| Propylene glycol | 2.0 |
| Octyldodeceth-16 | 0.4 |
| Sodium carboxy methyl cellulose | 0.3 |
| Polyoxyethylene hardened castor oil | 0.2 |
| Ethylenediamine sodium tetraacetate | 0.02 |
| Fragrance | Proper amount |
| Ag nano particles | 20 ppm |
| Au nano particles | 10 ppm |

### PREFERRED EMBODIMENT 13

Foundations and Make-Up Bases

Foundations and make-up bases are manufactured according to the components and mixing ratios shown in the following Table 15 by using the paramagnetic silver nano particles manufactured according to the method described in Manufacturing Example 3 for the paramagnetic silver nano particles to be added and using the paramagnetic gold nano particles manufactured under the conditions described in Manufacturing Example 5 for the paramagnetic gold nano particles:

TABLE 15

| Component | Content (wt %) |
|---|---|
| Purified water | Rest |
| Liquid paraffin | 10.0 |
| Tri(capric, caproic acid) glycerin | 10.0 |
| Titanium dioxide | 10.0 |
| Concentrated glycerin | 5.0 |
| Propylene glycol | 5.0 |
| Kaolin | 3.0 |
| Stearic acid | 2.0 |
| Monostearic acid polyoxyethylene sorbitan | 1.0 |
| sorbitan sesquioleate | 0.8 |
| Ferric oxide | 0.5 |
| Ferrous oxide | 0.5 |
| Triethanol amine | 0.2 |
| Ultramarine | 0.2 |
| Bentonite | 0.1 |
| Sodium carboxy methyl cellulose | 0.05 |
| Fragrance | Proper amount |
| Ag nano particles | 30 ppm |
| Au nano particles | 10 ppm |

### PREFERRED EMBODIMENT 14

Cleansing Lotions

Cleansing lotions are manufactured according to the components and mixing ratios shown in the following Table 16 by using the paramagnetic silver nano particles manufactured according to the method described in Manufacturing Example 3 for the paramagnetic silver nano particles to be added and using the paramagnetic gold nano particles manufactured under the conditions described in Manufacturing Example 5 for the paramagnetic gold nano particles:

TABLE 16

| Component | Content (wt %) |
|---|---|
| Polypropylene glycol | 3.5 |
| Polyquaternium | 2.6 |
| Cetareth and stearyl alcohol (Cremophr A6, BASF) | 1.6 |
| Silicon suspension 30% (Fluka Chemie AG, Switzerland, | 10.0 |
| Product No. 85390 Silicon antifoam) | |
| Au nano particles | 20 ppm |
| Ag nano particles | 25 ppm |
| Zinc oxide | 0.05 |
| Water | 82.0 |

### COMPARATIVE EXAMPLE 4

Essences

Essences are manufactured with the same components and mixing ratios as those of the above Preferred Embodiment 8 except that no paramagnetic silver nano particles are contained.

Next, the following tests are performed with the products manufactured in the above Preferred Embodiment 8 and Comparative Example 4.

### TESTING EXAMPLE 4

Experiments for the Effects for Skin Absorption, Sense of Touch and Pliability

The products manufactured in Preferred Embodiment 8 and Comparative Example 4 are offered to 30 subjects based on blind tests. The characteristics of skin absorption, sense of touch, and pliability of each composition are evaluated for each subject. Characteristic (1) is to evaluate whether the speed of absorption of a composition to the skin is fast, Characteristic (2) is whether a composition is not sticky but soft to the skin, and Characteristic (3) is whether a composition is pliable to the skin. Grading is shown in terms of 1 to 4 which mean very superior, superior, average, and inferior. The results of grading are shown in the following Table 17:

TABLE 17

| | | Very | | | |
|---|---|---|---|---|---|
| Sample | Characteristic | superior | Superior | Average | Inferior |
| Preferred | Absorption | 24 | 5 | 1 | 0 |
| Embodiment 8 | Touch | 21 | 6 | 3 | 0 |
| | Pliability | 18 | 8 | 4 | 0 |
| Comparative | Absorption | 7 | 7 | 12 | 4 |
| Example 4 | Touch | 5 | 9 | 10 | 6 |
| | Pliability | 7 | 9 | 8 | 6 |

As seen from the above Table 17, it is seen that essence compositions according to the present invention have more superior absorption property of active components to the skin as well as more superior sense of touch and pliability compared to the conventional essence compositions containing no paramagnetic silver nano particles.

### TESTING EXAMPLE 5

Effects for Increase in Skin Elasticity (Synergism of Active Components)

Formulations of Preferred Embodiment 8 are applied to the surroundings of left eyes of 20 patients twice a day in order to experiment the effects of increase in elasticity of the skin when nutritional essences containing skin elasticity improving active components in the formulations of Preferred Embodiment 8 and Comparative Example 4 are coated onto the skin. Formulations of Comparative Example 4 are applied to the surroundings of right eyes. The elasticity of skin surface is measured with Cutometer SEM 474 after each process. The measurement of skin elasticity with Cutometer SEM 474 is a method of measurement of the elasticity of skin through suction of epidermis with a negative pressure and measuring of the degree of suction. The smaller the value of suction is, the better the elasticity is. The value of elasticity is shown in terms of the value reduced in % compared to the value of the control group. The average value of those of 20 subjects is shown in the following Table 18. The values of the control group are measured values before samples are processed.

TABLE 18

Skin elasticity effect (days passed)

| Sample | 30 | 45 |
|---|---|---|
| Preferred Embodiment 8 | 21.4 | 32.5 |
| Comparative Example 4 | 9.1 | 13.6 |

It is seen from the above Table 18 that essence compositions according to the present invention increase the effects of active components.

### TESTING EXAMPLE 6

Tests for Antiseptic Power

In order to evaluate the antiseptic power of the cosmetic compositions of the present invention, mixed bacteria solutions of Escherichia coli (ATCC 8739), Staphylococcus aureus (ATCC 6538), Pseudomonas aeruginosa (ATCC 99027), etc. are added to 20 g of a cosmetics in the above Preferred Embodiment 8 to make the initial concentration per sample of 10⁶ cfu/g (colony forming unit/g). These are cultured in a 30 to 32° C. incubator for 4 weeks, and 1 g of each essence is taken at intervals of 1, 7, 14, 21, and 28 days in order to measure the number of alive bacteria. As a result of measurement, no alive bacteria are observed during the entire term of measurement. It is, therefore, seen that toner compositions according to the present invention have a superior antiseptic power.

### PREFERRED EMBODIMENTS 15 AND 16

Cosmetic Compositions

Cosmetic compositions are manufactured according to the components and mixing ratios shown in the following Table 19 by using the paramagnetic gold nano particles manufactured under the conditions described in Manufacturing Example 5 for the paramagnetic gold nano particles.

TABLE 19

| | | Preferred | Preferred |
|---|---|---|---|
| | | Embodiment | Embodiment |
| Component (wt %) | | 15 | 16 |
| Paramagnetic gold nano particles | | 10 (ppm) | 15 (ppm) |
| Diluent | Ethanol | 20 | 20 |
| Softner | Castor oil | 8 | 8 |
| Moisturizer | Dimethicone | 10 | 10 |
| Surfactant | Butylene glycol | 5 | 5 |
| Emulsifier | PEG-10 | 5 | 5 |
| | hydrogenated castor | | |
| | oil | | |
| Physioactive | Palmitin retinol | 3 | 3 |
| materials | Arbutin | 3 | 3 |
| Viscosity controller | Polyglyceryl | 1 | 1 |
| | methacrylate | | |
| Neutralizer | Triethanol amine | 0.5 | 0.5 |
| Chelating agent | Sodium tetraacetate | 0.5 | 0.5 |
| Astringent | Zinc stearate | 0.5 | 0.5 |
| Antiseptic | Ethylparaben | 0.5 | 0.5 |
| De-contaminant | Sodium tetraacetate | 0.5 | 0.5 |

| | | |
|---|---|---|
| Purified water | 43 | 43 |

### COMPARATIVE EXAMPLES 5 AND 6

The composition of Comparative Example 5 is manufactured in the same method as those of Preferred Embodiments 15 and 16 except that no paramagnetic gold nano particles are used, and the composition of Comparative Example 6 is manufactured according to the components and mixing ratios shown in the following Table 20:

TABLE 20

| | | Comparative | Comparative |
|---|---|---|---|
| Component (wt %) | | Example 5 | Example 6 |
| Diluent | Ethanol | 20 | 25 |
| Softner | Castor oil | 8 | 5 |
| Moisturizer | Dimethicone | 10 | 5 |
| Surfactant | Butylene glycol | 5 | 10 |
| Emulsifier | PEG-10 | 5 | 5 |
| | hydrogenated castor | | |
| | oil | | |
| Physioactive | Palmitin retinol | 3 | 3 |
| materials | Arbutin | 3 | 3 |
| Viscosity controller | Polyglyceryl | 1 | 1 |
| | methacrylate | | |
| Neutralizer | Triethanol amine | 0.5 | 0.5 |
| Chelating agent | Sodium tetraacetate | 0.5 | 0 |
| Astringent | Zinc stearate | 0.5 | 0 |
| Antiseptic | Ethylparaben | 0.5 | 0.5 |
| De-contaminant | Sodium tetraacetate | 0.5 | 0 |

| | | |
|---|---|---|
| Purified water | 43 | 42 |

### TESTING EXAMPLE 7

Experiments for Moisturizing Effects

The ability to retain moisture of the skin is evaluated by using a comeometer after coating fixed amounts of a cosmetic composition containing the paramagnetic gold nano particles of Preferred Embodiments 15 and 16 and a cosmetic composition not containing the paramagnetic gold nano particles of Comparative Examples 5 and 6 onto the skin.

A fixed amount of the composition is coated on the inner forearm of each of 20 subjects in a thermohydrostat room at 22° C. and a relative humidity of 50%, and rubbed well. The content of moisture of the skin according to the lapse of time is measured, and the results of measurement are shown in the following Table 21:

TABLE 21

| | Preferred | Preferred | | |
|---|---|---|---|---|
| | Embodiment | Embodiment | Comparative | Comparative |
| | 15 | 16 | Example 5 | Example 6 |
| Time (min) | (A.U.) | (A.U.) | (A.U.) | (A.U.) |
| 0 | 114 | 119 | 111 | 110 |
| 10 | 105 | 113 | 93 | 91 |
| 20 | 97 | 101 | 81 | 80 |
| 50 | 89 | 95 | 55 | 52 |
| 100 | 84 | 88 | 40 | 39 |

As seen in Table 21, the cosmetic compositions of Preferred Embodiments 15 and 16 containing paramagnetic gold nano particles have much more superior moisturizing effects than the cosmetic compositions of Comparative Examples 5 and 6 not containing gold nano particles.

### TESTING EXAMPLE 8

Experiments for the Effects for Skin Absorption and Sense of Touch

Cosmetic compositions manufactured in Preferred Embodiments 15 and 16 and Comparative Examples 5 and 6 are offered to 30 subjects based on blind tests. The characteristics of skin absorption and sense of touch of 4 compositions are evaluated for each subject. Characteristic (1) is to evaluate whether the speed of absorption of a composition to the skin is fast, and Characteristic (2) is whether a composition is not sticky but soft to the skin. Grading is shown in terms of 1 to 4 which mean very superior, superior, average, and inferior. The results of grading are shown in the following Table 22:

TABLE 22

| | | Very | | | |
|---|---|---|---|---|---|
| Sample | Characteristic | superior | Superior | Average | Inferior |
| Preferred | Absorption | 15 | 11 | 4 | 0 |
| Embodiment | Sense of touch | 14 | 10 | 6 | 0 |
| 15 | | | | | |
| Preferred | Absorption | 16 | 12 | 2 | 0 |
| Embodiment | Sense of touch | 15 | 11 | 4 | 0 |
| 16 | | | | | |
| Comparative | Absorption | 5 | 11 | 12 | 2 |
| Example 5 | Sense of touch | 5 | 12 | 11 | 2 |
| Comparative | Absorption | 4 | 13 | 10 | 3 |
| Example 6 | Sense of touch | 6 | 9 | 13 | 2 |

As seen in Table 22, all subjects show superior skin absorption and touching reactions to the cosmetic compositions of Preferred Embodiments 15 and 16 containing the paramagnetic gold nano particles according to the present invention. On the other hand, about half of the subjects shows average or inferior reactions to the compositions in Comparative Examples 5 and 6 not containing paramagnetic gold nano particles. It is, therefore, confirmed that the cosmetic compositions containing the paramagnetic gold nano particles according to the present invention have superior skin absorption and touching effects.

### INDUSTRIAL APPLICABILITY

Whereas the conventional gold or silver powder is diamagnetic, the paramagnetic gold or silver powder according to the present invention is high-purity gold or silver powder, which shows an extremely small coercive force, is stable at a room temperature although there are no surface oxidation layers, is not cohesive, but has a high dispersibility. It is, therefore, advantageous in that it may be used for various material areas.

While certain present manufacturing examples, preferred embodiments, and comparative examples of the present invention have been shown and described, it is to be distinctly understood that the present invention is not limited thereto but may be otherwise variously embodied and practiced within the scope of the following claims.

1-30. (canceled)

31. A paramagnetic nano powder comprising gold or silver powder having paramagnetism at an absolute temperature of 20 K or higher.

32. The paramagnetic nano powder of claim 31, wherein the size of particles of said gold or silver powder is 40 μm or less.

33. The paramagnetic nano powder of claim 31, wherein said gold or silver powder has paramagnetism at an absolute temperature of 100 K or higher.

34. The paramagnetic nano powder of claim 33, wherein said gold or silver powder has paramagnetism at room temperature.

35. The paramagnetic nano powder of claim 32, wherein said silver powder has paramagnetism in an external magnetic field, H, of 2,000 Oe or greater.

36. The paramagnetic nano powder of claim 35, wherein said silver powder has paramagnetism in an external magnetic field, H, of 4,000 Oe or greater.

37. The paramagnetic nano powder of claim 32, wherein said silver powder has a saturated magnetic moment in an external magnetic field, H, in the range of 2,000 to 8,000 Oe.

38. The paramagnetic nano powder of claim 32, wherein said gold or silver powder has super-paramagnetism at an absolute temperature of 100 K or lower.

39. The paramagnetic nano powder of claim 38, wherein the size of particles of said silver powder is 3 μm or less.

40. The paramagnetic nano powder of claim 38, wherein the size of particles of said gold powder is 20 nm or less.

41. The paramagnetic nano powder of claim 32, wherein said silver powder has a positive mass magnetization in which the slope of the mass magnetization curve, dM/dH, is positive at an absolute temperature of 100 K or lower.

42. The paramagnetic nano powder of claim 41, wherein said silver powder has a positive mass magnetization as the inclination of the mass magnetization curve, dM/dH, is 3×10⁻⁷ emu/g·Oe or greater at an absolute temperature of 20 K.

43. The paramagnetic nano powder of claim 32, wherein said silver powder has a positive mass magnetization in an external magnetic field, H, of 2,000 Oe or greater.

44. The paramagnetic nano powder of claim 43, wherein said silver powder has a positive mass magnetization in an external magnetic field, H, of 4,000 Oe or greater.

45. The paramagnetic nano powder of claim 32, wherein said gold powder has a positive mass magnetization as the inclination of the mass magnetization curve, dM/dH, is a positive value in an external magnetic field, H, of 1,000 Oe or greater.

46. The paramagnetic nano powder of claim 45, wherein said gold powder has a positive mass magnetization as the inclination of the mass magnetization curve, dM/dH, is 4×10⁻⁶ or greater in an external magnetic field, H, of 10,000 Oe at an absolute temperature of 20 K.

47. The paramagnetic nano powder of claim 32, wherein said gold or silver powder has a coercive force of 5 Gauss or less.

48. The paramagnetic nano powder of claim 47, wherein said gold or silver powder has a coercive force of 2 Gauss or less.

49. A method of manufacturing paramagnetic nano powder, comprising the steps of:
generating of a plasma having an absolute temperature in the range of 4,000 to 200,000 K by using an RF power amplifier of 13.56 MHz and 5 to 50 kW and an inductive coupled plasma torch in a vacuum reaction tube;
producing a gold or silver plasma gas by reacting said generated plasma and diamagnetic gold or silver powder; and
producing paramagnetic gold or silver powder by rapidly cooling said gold or silver plasma gas below a room temperature under a vacuum in a nano powder collection equipment installed at the lower end of a plasma reaction furnace.

50. The method of claim 49, wherein a single-type RF applied power is 7 kW or greater, or a double-type RF applied power is 5 kW or greater.

51. The method of claim 49, further comprising the step of controlling the size of paramagnetic gold or silver powder by adjusting the conditions selected from the length of the reaction flame in which plasma is formed, and the time or temperature of rapid cooling of said gold or silver plasma gas.

52. An epilation composition containing said silver powder having paramagnetism of claim 32, germanium dioxide, and purified water.

53. The epilation composition of claim 52, wherein the content of said silver powder is in the range of 0.01 to 10 ppm.

54. The epilation composition of claim 52, wherein the germanium dioxide is obtained by burning natural lignite in the range of 1,600 to 2,000° C. in a combustion furnace.

55. A toothpaste composition containing said silver powder having paramagnetism of claim 32.

56. The toothpaste composition of claim 55, wherein the content of said silver powder is in the range of 0.005 to 0.1 weight %.

57. A cosmetic composition containing said gold or silver powder having paramagnetism of claim 32, or their mixture.

58. The cosmetic composition of claim 57, wherein the content of said gold powder is in the range of 3 to 20 ppm.

59. The cosmetic composition of claim 57, wherein the content of said silver powder is in the range of 5 to 50 ppm.
